(19) United States
(12) Patent Application Publication
(10) Pub. No.: US 2025/0321781 A1
(43) Pub. Date: Oct. 16, 2025

(54) ENTANGLED THREADS

(71) Applicant: Samsung Electronics Co., Ltd., Suwon-si (KR)

(72) Inventors: Ali RAZA, Plano, TX (US); Rolf RIESEN, Forest Grove, OR (US); Ronald MINNICH, Livermore, CA (US); Robert W. WISNIEWSKI, Ossining, NY (US)

(21) Appl. No.: 18/919,422

(22) Filed: Oct. 17, 2024

Related U.S. Application Data
(60) Provisional application No. 63/634,921, filed on Apr. 16, 2024.

(51) Int. Cl. G06F 9/48

(52) U.S. Cl. CPC G06F 9/485

(57) ABSTRACT

Provided are systems, methods, and apparatuses for entangled threads. In one or more examples, the systems, devices, and methods include generating, via a host, a first thread of a process; generating, via the first thread, a second thread, the first thread configuring the second thread as a proxy of the first thread; and executing the second thread on an accelerator. In some examples, the first thread places itself in the sleep state while the second thread executes on the accelerator. In some examples, the systems, devices, and methods include configuring, via the host, the first thread to execute on a processor of the host, and configuring, via the first thread, the second thread to execute on the accelerator.

### CROSS-REFERENCE TO RELATED APPLICATIONS

This application claims the benefit of U.S. Provisional Patent Application Ser. No. 63/634,921, filed Apr. 16, 2024, which is incorporated by reference herein for all purposes.

### TECHNICAL FIELD

The disclosure relates generally to memory systems, and more particularly to entangled threads.

### BACKGROUND

The present background section is intended to provide context only, and the disclosure of any concept in this section does not constitute an admission that said concept is prior art.

In computing, a thread can be a sequence of instructions that a program or application gives to a processor to execute. Threads may be the smallest series of related instructions that make up a process, which can include multiple threads. For example, a thread might ask for user input or apply a mathematical algorithm to data. Threads can be used in many types of applications, including desktop software, web browsers, mobile apps, databases, and server-side software. Threading can increase the speed and efficiency of multitasking by allowing multiple threads to run on one or more cores in a single processor. However, threading can increase system overhead based on host supervision of threads and may include implementation inefficiencies based on source code modifications constraints involved with some threading.

### SUMMARY

In various embodiments, the systems and methods described herein include systems, methods, and apparatuses for entangled threads. In some aspects, the techniques described herein relate to a method of entangling threads, the method including: generating, via a host, a first thread of a process; generating, via the first thread, a second thread, the first thread configuring the second thread as a proxy of the first thread; and executing the second thread on an accelerator.

In some aspects, the techniques described herein relate to a method, wherein: the first thread is generated in a user memory space of the host, and the first thread enters a sleep state in a kernel memory space of the host.

In some aspects, the techniques described herein relate to a method, wherein the first thread places itself in the sleep state based on the second thread executing on the accelerator.

In some aspects, the techniques described herein relate to a method, wherein: the second thread is generated in the kernel memory space of the host, and the second thread executes in a memory space of the accelerator.

In some aspects, the techniques described herein relate to a method, further including: configuring, via the host, the first thread to execute on a processor of the host; and configuring, via the first thread, the second thread to execute on the accelerator.

In some aspects, the techniques described herein relate to a method, wherein, upon completing execution, the second thread provides a result of the execution to the first thread.

In some aspects, the techniques described herein relate to a method, wherein the first thread determines execution of the second thread is complete based on the first thread periodically polling the second thread.

In some aspects, the techniques described herein relate to a method, wherein the accelerator executing the second thread is viewed by the host as the first thread executing on a processor of the host.

In some aspects, the techniques described herein relate to a method, wherein the first thread configuring the second thread includes the first thread populating a memory location on a memory of the host that is accessible by the accelerator.

In some aspects, the techniques described herein relate to a method, wherein the first thread configuring the second thread includes the first thread populating a memory location of a memory of the accelerator.

In some aspects, the techniques described herein relate to a method, wherein the first thread configuring the second thread includes the first thread passing a message to the second thread that bypasses a processor of the host.

In some aspects, the techniques described herein relate to a method, further including: waking the first thread from a sleep state based on the second thread detecting a system interrupt and the second thread sending a wake-up command to the first thread; and pausing execution of the second thread.

In some aspects, the techniques described herein relate to a method, further including: processing, via the first thread, the system interrupt; and resuming execution of the second thread based on the second thread receiving a resume command from the first thread.

In some aspects, the techniques described herein relate to a method, wherein the first thread requests a metric from the second thread based on the first thread receiving a request for the metric from the host.

In some aspects, the techniques described herein relate to a method, wherein the host requests a metric from the second thread based on the host detecting that the second thread is the proxy of the first thread.

In some aspects, the techniques described herein relate to a method, wherein the host fetches a metric from a memory location of the accelerator to determine a status associated with execution of the second thread.

In some aspects, the techniques described herein relate to a method, wherein the second thread includes a pre-compiled binary packaged as a multiarchitecture binary.

In some aspects, the techniques described herein relate to a device including: one or more processors; and memory storing instructions that, when executed by the one or more processors, cause the device to: generate, via a host, a first thread of a process; generate, via the first thread, a second thread, the first thread configuring the second thread as a proxy of the first thread; and execute the second thread on an accelerator.

In some aspects, the techniques described herein relate to a device, wherein: the first thread is generated in a user memory space of the host, and the first thread enters a sleep state in a kernel memory space of the host.

In some aspects, the techniques described herein relate to a non-transitory computer-readable medium storing code that includes instructions executable by a processor of a device to: generate, via a host, a first thread of a process; generate, via the first thread, a second thread, the first thread configuring the second thread as a proxy of the first thread; and execute the second thread on an accelerator.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The systems and methods described herein include multiple advantages and benefits. For example, the systems and methods described herein enable existing libraries and runtimes to take advantage of accelerator cores without source code modifications or with minimal source code modifications. Also, the systems and methods provide accelerators cores (e.g., dedicated accelerator cores) that avoid the overhead of scheduling via a host or operating system. By minimizing or avoiding scheduling of threads via host or operating system, the systems and methods provide accelerator cores with less overhead and operating system noise than cores that operate under operating system management. Accordingly, the systems and methods of entangled threads described herein provide multiple advantages and benefits that increase efficient use of system resources, streamline implementation, and improve system performance.

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein:

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 illustrates an example system in accordance with one or more implementations as described herein.

FIG. 5 depicts a flow diagram illustrating an example process flow associated with the disclosed systems, in accordance with example implementations described herein.

FIG. 6 depicts a flow diagram illustrating an example method associated with the disclosed systems, in accordance with example implementations described herein.

FIG. 7 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some example embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Any data processing may include data buffering, aligning incoming data from multiple communication lanes, forward error correction (“FEC”), and/or others. For example, data may be first received by an analog front end (AFE), which prepares the incoming for digital processing. The digital portion (e.g., digital signal processors (DSPs)) of the transceivers may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, system-on-a-chip, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

The systems and methods described herein may implement and/or may be based on one or more processes and/or one or more threads of the one or more processes. A process may include an executing program. An application may be made up of one or more processes. A thread can include a unit of execution within a process. A process may include one or more threads. A process may be started with an initial thread or primary thread. When a process starts, the process may receive compute resources (e.g., memory, storage, processing, and/or other computing resources). One or more threads of a process may share those resources.

The systems and methods described herein may implement and/or may be based on accelerators. Accelerators can be used to speed up computer workloads (e.g., AI workloads). These workloads include machine learning (ML), deep learning (DL), and neural networks. Accelerators can include AI accelerators, which can be referred to as AI chips, neural processing units (NPUs), deep learning processors, high-performance hardware accelerators, etc. Accelerators can be configured to handle the unique requirements of workloads efficiently (e.g., AI workloads). Accelerators can use multiple core designs (e.g., manycore processors) and can be configured to focus on low-precision arithmetic, novel dataflow architectures, in-memory computing capability, etc. Accelerators can leverage parallelism and tailored memory hierarchies to deliver speed and energy efficiency in computations. Accelerators can be used in many typical applications, including algorithms for robotics, the Internet of Things, and other data-intensive or sensor-driven tasks. For example, accelerators can be used on standard data center servers to extract meaningful patterns from large datasets.

The systems and methods described herein may implement and/or may be based on high-performance computing (HPC) systems. HPC can include the practice of combining computing resources to solve large problems in science, engineering, or business. HPC can provide greater performance than a single workstation, server, or computer. HPC can work by connecting multiple computers, or nodes, into a cluster using a high-speed network. These clusters are built with high-performance processors, high-speed memory and storage, and other advanced components. HPC can be used to integrate new data, increase model resolution, develop, implement, and disseminate techniques and tools, solve problems that are too complex for a desktop computer, etc.

The systems and methods described herein may implement and/or may be based on a system runtime (e.g. runtime system, runtime system software, runtime environment). A system runtime can include code that enables a program to function (e.g., code that operates in conjunction with an operating system). In some cases, a system runtime may create a layer over an operating system that includes other programs that handle tasks that get a main program running. These other programs may be configured to handle tasks such as allocating memory for the main program and scheduling execution of the main program, etc. A system runtime can refer to the execution of a program in a runtime environment. For example, system runtime may include execution of a program in an operating system in conjunction with utilization of runtime resources that may include at least one of a processor, a cache, a memory, an accelerator, a storage drive, and/or a network communication interface. A system runtime can include systems (e.g., subsystems) that exist both in a computer where a program is created, as well as in computers where the program is intended to be run. Runtime can refer to the compile time and runtime division from compiled languages, which similarly distinguishes the computer processes involved in the creation of a program (compilation) and its execution in the target machine (the runtime). A system runtime may address the management of application memory, how the program accesses variables, mechanisms for passing parameters between procedures, interfacing with the operating system (OS), among others. The compiler can make assumptions depending on the specific system runtime to generate correct code. In some cases, the system runtime may have some responsibility for setting up and managing the stack and heap, and may include features such as garbage collection, threads or other dynamic features built into the language. A system runtime can include the gateway through which a running program interacts with the runtime environment. The runtime environment can include accessible state values as well as active entities with which the program can interact during execution. For example, environment variables may be features of a given operating system, and may be part of the runtime environment. A running program can access environment variables via the runtime system. In some cases, hardware devices (e.g., storage drives, peripherals, etc.) may be active entities that a program can interact with via a system runtime.

The systems and methods described herein may implement and/or may be based on a stack and/or a heap. The stack may include a reserved area of memory (e.g. of the host, of the system runtime) that stores local variables and manages function calls during program execution. When a process ends, the memory allocated to the variables of the process may be freed up for other processes. The heap may include a region of memory used for dynamic memory allocation, where memory blocks may be allocated and released in an arbitrary order. The heap may be more flexible than the stack and can hold larger amounts of data. The heap may be slower than the stack, but may be more useful (e.g., for storing generic items like variables and data).

The systems and methods described herein may implement and/or may be based on cache coherence. Cache coherence can include mechanisms in computer architecture that ensure data consistency in a shared memory system (e.g., consistency of data stored in multiple caches within a multiprocessor or multicore system). With cache coherence, each processor or core may have its own cache memory to improve performance. When multiple processors access and modify the same data at the same time, cache coherence protocols may be used to manage the flow of data between caches. Cache coherence can enable hardware accelerators to use memory that is shared with multiple processors in a cache coherent manner. In some cases, each cache may hold a copy of frequently accessed data in a system with multiple processors or accelerators.

The systems and methods described herein may implement and/or may be based on profilers or thread profilers. Thread profilers (e.g., of a host, of an operating system, of a system runtime, etc.) may be configured to identify bottlenecks in an application by analyzing the performance of the application's threads. Thread profilers can measure how long it takes a method to run, how much processor and memory a method uses, and/or the invocation count of a given method. Thread profilers can periodically (e.g., every 100 ms) capture the stack trace of each thread (e.g., for a specified duration), and aggregate the stack traces to create a tree. The tree's call count can show how often a function appeared in the stack traces, providing a profile of a given thread.

The systems and methods described herein may implement and/or may be based on fat binaries. A fat binary (e.g., multiarchitecture binary) may include a computer executable program or library that has been expanded (e.g., fattened) with code native to multiple instruction sets (e.g., x86, reduced instruction set (RISC), complex instruction set (CISC), very long instruction word (VLIW), single instruction, multiple data (SIMD), etc.). Consequently, the fat binary can be run on multiple processor types, where the fat binary file results in a file larger or fatter than a one-architecture binary file.

The systems and methods described herein may implement and/or may be based on Artificial intelligence (AI), such as AI processes, AI accelerators, etc. AI can include a branch of computer science that uses technologies to enable computers to perform advanced functions that normally require human intelligence. AI systems can use algorithms, data, and computational power to simulate human reasoning, decision-making, and learning from experience. The goal can be to create intelligent systems that can solve complex tasks and perform a wide range of functions, such as computer vision, understanding and translating language, learning from new information, recognizing patterns, making decisions, etc. AI systems can use logic and decision trees to learn, reason, and self-correct. The systems and methods described can be implemented in executing processes (e.g., accelerating execution of processes) associated with self-driving cars, image recognition programs, virtual assistants, content creation, art, media, personalized recommendations, product optimization, inventory planning, logistics, and the like.

The systems and methods provide a mechanism to allow work to be scheduled on an accelerator as if the work were being scheduled on a native thread. The systems and methods provide a mechanism to enable the use of hardware accelerators with minimal or no changes to application software and minimal or no changes to a runtime system that is utilizing the accelerator. Instead of executing on a processor of a host, a native thread may arrange for the work to be offloaded to the accelerator. The systems and methods provide offloading of workloads that are originally scheduled on a host processor (e.g., central processing unit (CPU)), offloading a given workload to an accelerator without modifying the application. The systems and method may include spawning a pair of entangled threads that include a native thread to act as a placeholder on the host processor for the accelerated thread. In some cases, entangled threads may execute in the same address space (e.g., memory shared by the native thread and the accelerated thread).

Hardware accelerators for HPC and AI workloads can come in many forms. Hardware accelerators can be embedded in a CPU (e.g., vector processing units, data stream encryption engines, etc.); can include additional CPU cores with specialized capabilities; can be external to the CPU but on the same die as the CPU; and/or can be external to the die. Example of the latter two can include GPUs or additional CPU cores that may be configured with specialized capabilities (e.g., low power operations, tensor matrix multipliers, etc.). A difficulty in using these accelerators is in efficiently handing off tasks to the accelerators without significantly changing the runtime system software and/or the HPC/AI applications (the user-level software).

Based on entangled threads, the systems and methods enable efficient use of these accelerators without significantly changing the runtime system software or the HPC/AI applications. Entangled threads can include pairs of threads. A first thread of the pair of entangled threads may be seen by the OS (e.g., host) and the user-level software as a thread executing on the host CPU. The second thread may execute on the accelerator and perform the computational work. The two threads may be considered entangled because while the first thread is dormant on the host CPU, the first thread nevertheless reflects the state of the second thread performing its task on the accelerator. When the accelerated thread finishes, the host CPU thread wakes up and informs the host OS and user-level application that the task has been completed. From the OS and application's perspective, the work appears to have been performed on the host CPU rather than where it actually was performed (e.g., on the accelerator). The systems and methods include a coupled accelerator system where the host CPU and the accelerator may share memory and/or a data cache. In some cases, the CPU and accelerator may execute a similar instruction set. The systems and methods can apply to other types of accelerators (e.g., of an instruction set different than that of the CPU, etc.).

With some systems, an accelerator may have its own unique way of launching work and may require explicit methods to do so. Such systems can involve implementing new programming languages (e.g., SYCL, vendor-specific APIs, etc.). For some CPU accelerators, implementation can include treating accelerator cores as ordinary CPU and let the OS handle scheduling and task assignments for the accelerators. This overhead can introduce scaling limits due to OS locking mechanisms, and can result in inefficient use of resources due to sharing of accelerator CPUs with non-compute tasks. Such configurations can also introduce OS noise, further limiting scalability.

The systems and methods described herein include logic to provide entangled threads. The logic includes any combination of hardware (e.g., at least one memory, at least one processor), logical circuitry, firmware, and/or software to provide entangled threads. The systems and methods include a mechanism to enable the use of hardware accelerators without significant changes to the application software and no or minimal changes to runtime system that is utilizing the accelerator. The systems and methods include a mechanism with and without cache coherence. The systems and methods include a mechanism with and without the same instruction set architecture (ISA), using fat binaries if not. A fat binary, also known as a multiarchitecture binary, can include a computer program or library that has been expanded with code for multiple instruction sets. This allows the program to run on multiple processor types, resulting in a file that is larger than a normal one-architecture binary file.

The systems and methods described herein may implement and/or may be based on a proc file system (e.g.,/proc directory). The proc file system may include a virtual file system in some operating systems. The proc file system may provide information about the current state of the kernel and running processes. The proc file system may be created dynamically and mounted at boot time. The proc file system may include flags. A flag may include an indicator (e.g., one or more bits that represent a status or feature of a process or system component). Flags allow users to check if a particular function or capability is currently enabled or disabled by reading the value of that flag within a file. A flag can be configured as an on/off switch for a feature or setting within the system (e.g., enabling entangled threads).

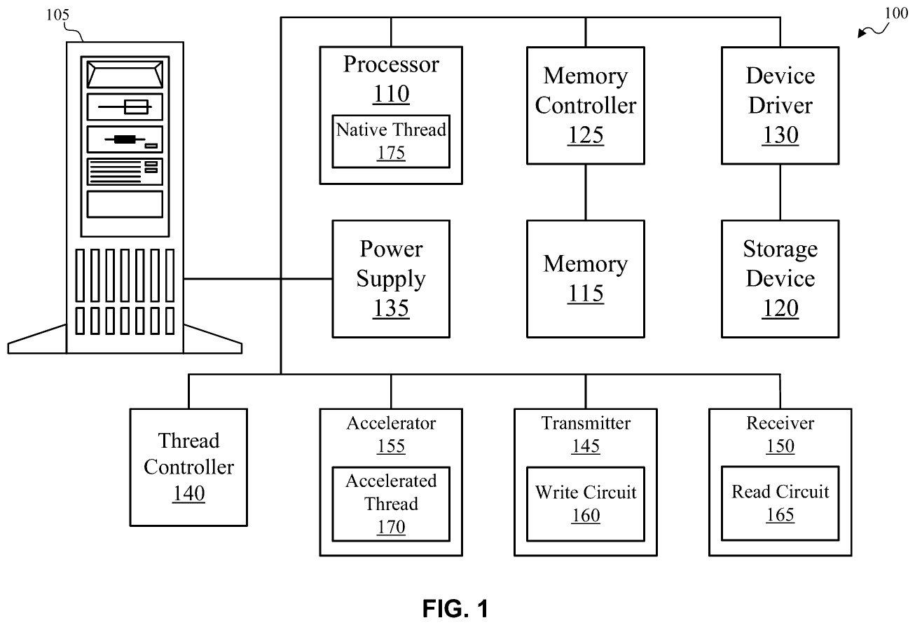

FIG. 1 illustrates an example system 100 in accordance with one or more implementations as described herein. In FIG. 1, machine 105, which may be termed a host (e.g., host 105), a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe) interface, or a Compute Express Link (CXL) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include write circuit 160, which may be used to write data into storage, such as a register, in memory 115 and/or storage device 120. In a similar manner, receiver 150 may include read circuit 165, which may be used to read data from storage, such as a register, from memory 115 and/or storage device 120. In the illustrated example, system 100 (e.g., machine 105 of system 100) may include one or more accelerators (e.g., accelerator 155). Accelerator 155 may include a hardware accelerator and/or a software accelerator. In one or more examples, processor 110 may include at least one accelerator of system 100 (e.g., at least one accelerator embedded in processor 110). Accelerator 155 may be configured to perform one or more operations based on the systems and methods described herein. In some cases, at least one accelerator of system 100 may include local memory. As shown, accelerator 155 may execute accelerated thread 170. In some cases, accelerator 155 may read data from and/or write data to a memory local to accelerator 155 based on the systems and methods described herein. Additionally, or alternatively, accelerator 155 may read data from and/or write data to memory 115 based on the systems and methods described herein. In some cases, at least a portion of memory 115 may be shared between a thread of accelerator 155 and a thread of processor 110.

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), optical processing units (OPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, thread controller 140 functionality, and/or the like, may be implemented with hardware, software, firmware, or any combination thereof including, for example, hardware and/or software combinational logic, sequential logic, timers, counters, registers, state machines, volatile memories such as at least one of or any combination of the following: dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), GPUs, NPUs, TPUs, OPUs, and/or the like, executing instructions stored in any type of memory. In some embodiments, one or more components of thread controller 140 may be implemented as an SoC.

In some examples, thread controller 140 may include any one or combination of logic (e.g., logical circuit), hardware (e.g., processing unit, memory, storage), software, firmware, and the like. In some cases, thread controller 140 may perform one or more functions in conjunction with processor 110, accelerator 155, memory controller 125, and/or memory 115. In some cases, at least a portion of thread controller 140 may incorporate and/or be incorporated in by processor 110, accelerator 155, memory controller 125, and/or memory 115. In some cases, at least a portion of thread controller 140 may incorporate and/or be incorporated in a system runtime, runtime environment, operating system, and/or a host of system 100. The one or more logic circuits of thread controller 140 may include any one or combination of multiplexers, registers, logic gates, arithmetic logic units (ALUs), cache, computer memory, microprocessors, processing units (CPUs, GPUs, NPUs, and/or TPUs), FPGAs, ASICs, etc., that enable thread controller 140 to provide the systems and methods of entangled threads as described herein.

In one or more examples, thread controller 140 may perform and/or provide one or more functions of the systems and methods of entangled threads described herein. In one or more examples, thread controller 140 may generate a first thread of a process, generate a second thread, configure the second thread as a proxy of the first thread, and execute the second thread on the accelerator. In some cases, first thread may be generated in a user memory space of a host. The first thread places itself in the sleep state while the second thread executes on the accelerator. In some cases, he first thread may enter a sleep state in a kernel memory space of the host. The second thread may be generated in the kernel memory space of the host and the second thread may execute in a memory space of the accelerator. In some cases, thread controller 140 may configure the first thread to execute on a processor of the host and configure the second thread to execute on the accelerator. Upon completing execution, the second thread may provide a result of the execution to the first thread. In some cases, the first thread may determine execution of the second thread is complete based on the first thread periodically polling the second thread. For example, the first thread may periodically wake up, poll the second thread, receive a poll response from the second thread, and return to sleep based on the poll response indicating the

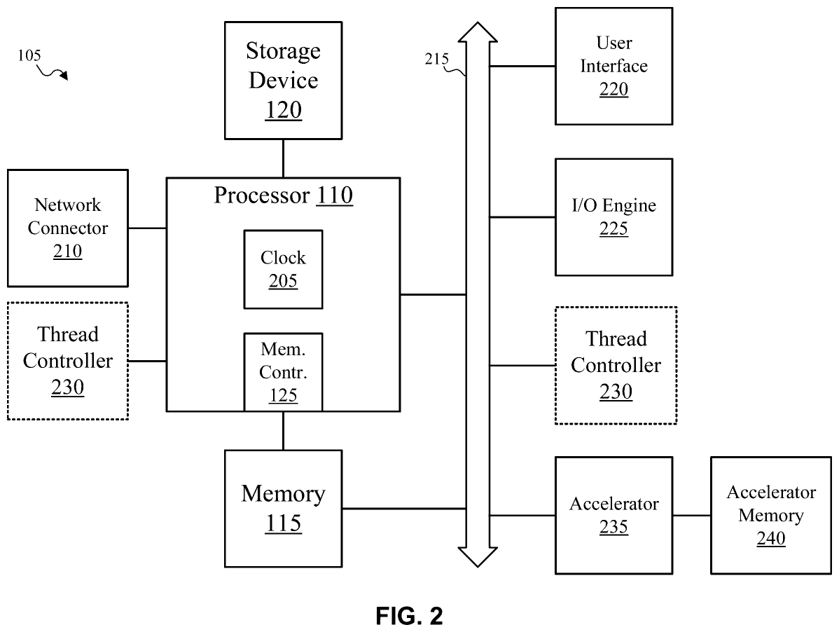

FIG. 2 illustrates details of machine 105 of FIG. 1, according to examples described herein. In the illustrated example, machine 105 may include one or more processors 110, which may include memory controllers 125 and clocks 205, which may be used to coordinate the operations of the components of the machine. Processors 110 may be coupled to memories 115, which may include random access memory (RAM), read-only memory (ROM), or other state preserving media, as examples. Processors 110 may be coupled to storage devices 120, and to network connector 210, which may be, for example, an Ethernet connector or a wireless connector. Processors 110 may be connected to buses 215, to which may be attached user interfaces 220, Input/Output (I/O) interface ports that may be managed using I/O engines 225, and one or more accelerators (e.g., accelerator 235), among other components. Accelerator 235 may be an example of accelerator 155 of FIG. 1. As shown, processors 110 may be coupled to thread controller 230, which may be an example of thread controller 140 of FIG. 1. Additionally, or alternatively, processors 110 may be connected to buses 215, to which may be attached thread controller 230.

In some examples, accelerator 235 may include and/or be attached to accelerator memory (e.g., accelerator memory 240). In some cases, accelerator memory 240 may include flash memory (e.g., NAND flash), DRAM, and/or cache memory. In some cases, accelerator memory 240 may be shared by accelerator 235 and one or more other components of machine 105 (e.g., processor 110). In some cases, memory 115 may include at least a portion of accelerator memory 240. In some cases, processor 110 and/or accelerator 235 may include cache memory. In some cases, cache of processor 110 may include at least a portion of accelerator memory 240. In some cases, cache of accelerator 235 may include at least a portion of accelerator memory 240. As shown, accelerator memory 240 may be accessed via accelerator 235. In some cases, accelerator memory 240 may be accessed independently of accelerator 235 (e.g., accessed via bus 215, accessed via memory 115).

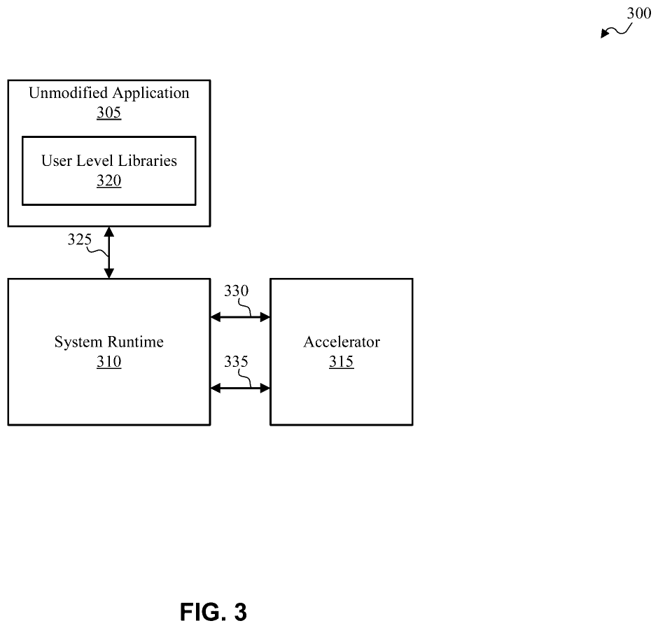

FIG. 3 illustrates an example system 300 in accordance with one or more implementations as described herein. In the illustrated example, system 300 may include unmodified application 305, system runtime 310, and accelerator 315. Accelerator 315 may be an example of accelerator 155 of FIG. 1 and/or accelerator 235 of FIG. 2. As shown, unmodified application 305 may include user level libraries 320. In some cases, system runtime 310 may include a host or host system, an operating system (e.g., of the host system), a runtime environment (e.g., of the host system), etc., or any combination thereof.

As shown, system 300 may include system call interface 325 between unmodified application 305 and system runtime 310. The systems and methods described herein may implement and/or may be based on system calls. A system call can be a way for a computer program to request services from an operating system that the program is running on. System calls can be used for a variety of tasks, including accessing hardware, creating and executing new processes, communicating with kernel services, and the like. In some cases, a System Call Monitor (SCM) may check system calls at runtime and allow or disallow a system call based on whether the system call matches the application's policy.

In some examples, unmodified application 305 may include an application that can be used with the systems and methods described herein without modifying the application. For example, the systems and methods of generating and implementing entangled threads (e.g., a native thread entangled with an accelerated thread) may be implemented on a set of instructions of a given application with modifying the application. Thus, the systems and methods described herein may be implemented in conjunction with unmodified application 305. At 330, a native thread generated by a host may offload a task of unmodified application 305 (e.g., without modification to the application). At 335 system runtime 310 may manage one or more aspects of accelerator 315.

Accelerator 315 may include a device configured to execute a subset of binary instructions of a host CPU (e.g., processor 110). The CPU/accelerator configuration may include little cores and/or big cores (e.g., a little core in a big core/little core configuration). The little cores may be used as accelerators and may not be used by the OS (e.g., the OS does not schedule work on the little cores). The OS may schedule work on the big cores. Little cores may have features not present in big cores (e.g., vector units). The systems and methods may enable vector compile for function files (e.g., only for function files) that will be offloaded to little cores. The systems and methods may embed check whether current CPU supports vector instructions.

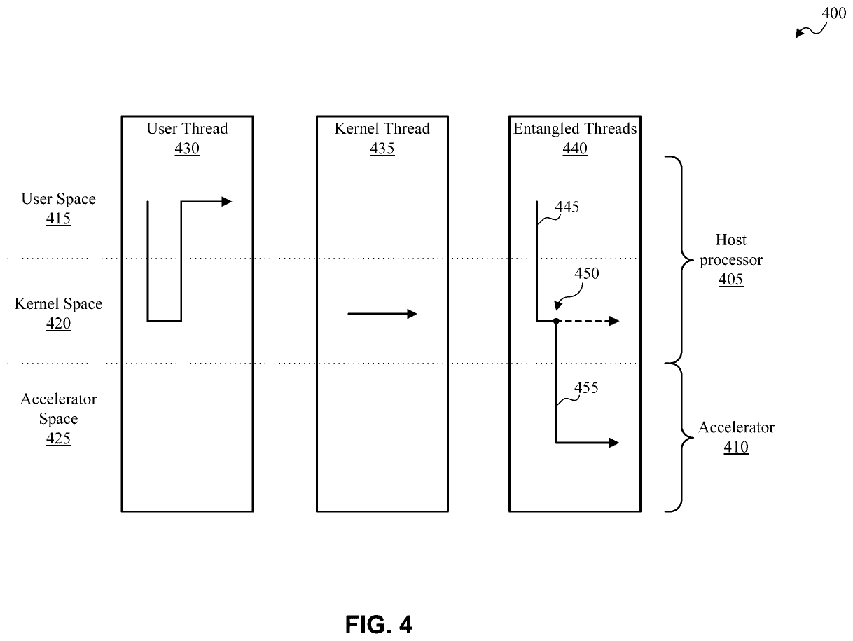

FIG. 4 illustrates an example system 400 in accordance with one or more implementations as described herein. In the illustrated example, system 400 may include host processor 405 and accelerator 410. As shown, host processor 405 may include user space 415 and kernel space 420. As shown, accelerator 410 may include accelerator space 425. In the illustrated example, system 400 may include user thread 430, kernel thread 435, and/or entangled threads 440. Accelerator 410 may be an example of accelerator 155 of FIG. 1, accelerator 235 of FIG. 2, and/or accelerator 315 of FIG. 3. Host processor 405 may be an example of processor 110 of FIG. 1 or FIG. 2.

In some examples, kernel space 420 may be reserved for running privileged operating system kernels, kernel extensions, device drivers, etc. User space 415 may include a memory space where application software (e.g., user applications) and/or some drivers may execute. Accelerated space 425 may include a memory space where accelerated tasks (e.g., threads, processes) may execute.

In the illustrated example, user thread 430 may be initiated in user space 415, generated and configured in the kernel space 420, and executed in user space 415. As shown, kernel thread 435 may be initiated, configured, and/or executed in kernel space 420.

In the illustrated example, entangled threads 440 may include native thread 445 and accelerated thread 455. Based on the systems and methods described herein, native thread 445 may be initiated in user space 415, then generated and configured in kernel space 420. At 450, native thread 445 may generate accelerated thread 455. Also at 450, native thread may enter a sleep state (e.g., in kernel space 420). As shown, accelerated thread 455 may be initiated in kernel space 420 and executed in accelerator space 425. In some cases, accelerated thread 455 may be configured in kernel space 420.

Accordingly, based on the systems and methods described, a native thread may be initiated in a user space. The native thread may generate an accelerated thread in a kernel space, configure the accelerated thread in the kernel space, and execute the accelerated thread in an accelerated space. In some cases, the native thread may enter a sleep state in the kernel space while the accelerated thread executes in the accelerated space.

In some cases, runtime system software (e.g., system runtime 310) may be modified to identify and interact with hardware accelerators (e.g., accelerator 315) to offload work. HPC/AI applications (e.g., user-level software) can be ported to use a different programming model or offload libraries, or compiled (e.g., re-compiled) for a different architecture. The systems and methods described herein provide mechanisms to allow unmodified applications to take advantage of accelerators, with little to no modification to system software. The systems and methods provide a mechanism to allow the runtime system software to schedule work on an accelerator.

The systems and methods provide mechanisms to allow work to be scheduled on an accelerator (e.g., accelerator 315) as if the work were being scheduled on a native thread (e.g., native thread 445). In order to provide this capability, native thread 445 may be spawned on a host CPU (e.g., host processor 405). In some cases, a native thread may be spawned on the host CPU for each core of an accelerator (e.g., accelerator 410). A given native thread (e.g., native thread 445) may serve as a representative of an accelerated thread (e.g., accelerated thread 455) of a given accelerator core in the runtime system software. The native thread and accelerated thread may be referred to as entangled threads. In some examples, entangled threads may be spawned based on accelerator 410 being attached to a CPU, based on a system startup, and/or as work arrives. In some examples, when an application (e.g., AI user application, HPC user application) starts work that can be offloaded to accelerator 410, entangled threads may be spawned/scheduled for the job. Instead of executing the job on a host CPU, native thread 445 may arrange for the work to be offloaded to accelerator 410. This offloading can include native thread 445 populating data structures in pre-specified or arbitrary memory locations of the host that are accessible to accelerator 410. Additionally, or alternatively, the offloading can include native thread 445 populating memory locations on memory of accelerator 410 and/or message passing based on the runtime of accelerator 410 being configured to receive data structures without host CPU intervention (e.g., message passing that bypasses host processor 405).

In some examples, accelerator 410 may execute the offloaded work and once finished, accelerator 410 may respond with results/data in a similar fashion. Native thread 445 can poll accelerator 410 (e.g., periodically query accelerator 410 if the work is finished until receiving a reply) or native thread 445 can wait to be interrupted by accelerator 410 (e.g., based on accelerator 410 triggering an interrupt) once the work is finished. The runtime system software may then progress as if the work was completed by native thread 445, and the user application would not know the difference. In some cases, accelerator 410 may wake up native thread 445 during execution of accelerated thread 455 when an unexpected instruction or request occurs (e.g., a system call). In some cases, native thread 445 may process the request regarding the unexpected instruction natively and respond back to accelerated thread 455 and/or accelerator 410 to resume execution of accelerated thread 455. In some cases, cache coherence between host processor 405 and accelerator 410 may be handled in one of multiple ways. In some cases, at least one of host processor 405 or accelerator 410 may include a cache. In some examples, host processor 405 and accelerator 410 may share a cache memory. In some cases, there may be no caches implemented on host processor 405 and/or no caches implemented on accelerator 410. In some cases, a software protocol may coordinate cache coherence information between host processor 405 and accelerator 410. In some cases, host processor 405 and accelerator 410 may have the same architecture (e.g., same instruction set architecture (ISA)), or may have different architectures. In cases where host processor 405 and accelerator having different architectures (e.g., different ISAs), the offloaded binary may be pre-compiled for accelerator 410 and packaged as a fat binary. In some cases, tools and utilities that work on native threads (e.g., for time-keeping purposes) may run as expected. In this case, the entangled thread can communicate with accelerator 410 and report back the desired metrics. In some cases, the runtime system software can detect that the native thread is being profiled and instead communicate with accelerator 410 or fetch this data from a pre-specified memory location.

In some examples, a process may spawn a thread to execute work on host processor 405. In some cases, an application associated with the process may be pre-profiled (e.g., pre-determined to be compatible with entangled threads, processes of the application pre-selected for entangled threads, etc.). In some cases, a user may request (e.g., instruct the OS) to use an entangled thread for the work of the process instead of spawning a regular thread to execute it. Once spawned, native thread 445 may run a routine (e.g., custom routine, entangled threads routine) instead of a routine (e.g., default routine) provided by the application. The custom routine may configure accelerator 410 (e.g., configure page tables, populate memory locations with the details of the routines and arguments associated with executing the work of the process). In some cases, the custom routine may provide configuration information associated with executing the work of the process. Once the custom routine is finished executing, native thread 445 may let accelerator 410 execute the work of the process (e.g., execute accelerated thread 455). In some cases, native thread 445 may place itself into a sleep state after the custom routine is finished and/or upon accelerator 410 initiating the work of the process (e.g., initiating execution of accelerated thread 455).

Once accelerator 410 finishes the work, accelerator 410 may write the results of executing the work to a location (e.g., a location indicated by the configuration information, indicated by the custom routine, etc.). In some cases, accelerator 410 may interrupt native thread 445 by writing to a memory location (e.g., a memory location specified by the configuration information). In some cases, the OS may detect a page fault (e.g., based on accelerator 410 writing to the memory location) and the OS may determine the page fault is a special case associated with entangled threads. Accordingly, instead of servicing the page fault, the OS may wake up native thread 445. In some cases, native thread 445 may then collect the results and/or data from the specified memory location and execute the next instruction of the process that would have been executed if the work executed by accelerator 410 had been executed natively by host processor 405. In some cases, executing the next instruction can include accelerator 410 passing the results of executing the accelerated thread back to the main application thread and then exiting. Any system calls or I/O calls that occur while accelerator 410 is running the code (e.g., executing the work of the process) may be serviced by interrupting native thread 445. Native thread 445 may respond back with the results and go back to a sleep state.

In some examples, the OS may identify entangled threads (e.g., mark native thread 445 and/or accelerated thread 455 as identified). Accordingly, any utilities or profilers that act on native thread 445 can be routed appropriately (e.g., to routines that fetch that information). Any calls to terminate the process or entangled threads may result in the OS resetting accelerator 410 and clearing all memory associated with the entangled threads.

In some examples, entangled threads may be marked at creation (e.g., using a new flag to clone( )/clone3( ), or just before the clone( ) call, which may include setting a flag in the kernel that this task's next clone call will create entangled threads based on calling clone( ). Based on the systems and methods, clone( ) calls embedded in libraries (e.g., pthread and OpenMP) do not need to be modified to enable entangled threads. In some cases, when an entangled threads are implemented, the OS side of the entangled threads (e.g., native thread 445) may be in a sleep state, while the accelerator side of the entangled threads executes the code of the thread (e.g., accelerated thread 455) on accelerator 410. When the accelerator returns, the OS side (e.g., native thread 445) may wake up and return to user space 415.

The systems and methods may provide a single thread abstraction that enables the use of hardware CPU accelerators by transparently executing entangled threads on both host processor 405 and accelerator 410. The systems and methods may provide a new thread type (e.g., new thread type in LINUX®, entangled threads). The systems and methods may use task_struct to add a new entry creating entangled threads, which may include information to manage this new thread type. Entangled threads may be similar in some respects to user threads, but with added functionality. Entangled threads may start in user space 415 similar to user threads, but after trapping into kernel space 420, entangled threads may not return to user space 415. Entangled threads may be marked TASK_INTERRUPTIBLE while the execution continues on accelerator 410. In some host systems, TASK_INTERRUPTIBLE may be a task state that indicates a task (e.g., process, thread) is sleeping while waiting for a condition to be met and/or for a signal to be received. When the condition is met or the signal is received, the task will transition to the TASK_RUNNING state. TASK_RUNNING may be a state that indicates a task is runnable and is either currently running or waiting to run on a run queue. Thus, TASK_RUNNING identifies a process that is executing on a processor, or waiting to be executed, while TASK_INTERRUPTIBLE identifies a process that is suspended (e.g., sleeping) until some condition becomes true. A new proc flag (e.g., proc entry, field) may be set (e.g., set to binary 1 to enable entangled threads) to enable entangled threads. For example, a proc flag may be switched on (e.g., switched from binary 0 to 1) to enable entangled threads for one or more applications. In some cases, the proc flag may be switched on for at least one application (e.g., setting a single proc flag for multiple applications; setting a first proc flag for a first application and setting a second proc flag for a second application, etc.). Setting a proc flag may be a way of informing the host or operating system to create entangled threads on clone( ) calls. For example, a proc flag may indicate to a host or operating system that from now on the clone( ) call is to be treated as a special clone( ) call (e.g., a clone( ) call configured or customized for entangled threads). Thus, instead of creating another regular thread, an entangled thread may be created based on the proc flag being switched on. . . . In one or more examples, the proc flag may be switched based on a user command. In some cases, a host or OS may profile one or more applications and identify threads (e.g., compute bound threads) of a given application for offloading as entangled threads (e.g., identify threads that are ideal for offloading as entangled threads). In some cases, the host/OS may determine that some types of applications (e.g., AI applications, HPC applications, etc.) are well suited for entangled threads. Accordingly, in some examples, the proc flag may be switched on by the host/OS based on application type (e.g., based on host/OS application profiling). In some cases, a host/OS may profile an application (e.g., a new type of application, an unknown application), identify threads of the application for offloading as entangled threads, and execute the entangled threads accordingly (e.g., based on switching the proc flag for the identified threads of that application).

In some cases, the user-kernel boundary (e.g., boundary between user space 415 and kernel space 420) may be used to spawn entangled threads. Entangled threads may be spawned based on a thread that is about to transition back into user space 415 after being trapped into kernel space 420 based on a syscall, timer interrupt, page fault or other exception. Entangled threads may be spawned based on a new thread being cloned (e.g., cloning native thread 445) and before the new thread transitions to user space 415.

In some examples, instead of setting up the instruction pointer, stack pointer and other registers and then executing IRET or SYSRET etc., the original register state etc., may be saved to be restored later. In some cases, the instruction pointer may be set to a function configured to put the thread to sleep. The saved register state may be used to set up the accelerator so it knows where to resume the execution from and what are the correct arguments or the correct state to resume that execution. In some cases, native thread 445 may use assembly code instructions (e.g., IRET, RET) to remain in kernel space 420 while running a procedure that puts native thread 445 in a sleep state. The IRET instruction may be used to exit an interrupt procedure. Similarly, the RET instruction may be used to return from a procedure or subroutine. RET may transfer control to the return address located on the stack, where the return address may be placed on the stack by a call instruction. RET may be used to resume execution flow at the instruction following the call. Accordingly, the native thread may use IRET and/or RET to remain in the kernel space and/or to exit the kernel space.

Any attempts by a profiler to get information about native thread 445 may result in an “unsupported operation” message by default, unless functions are implemented that gather data from native thread 445 and/or accelerated thread 455 and respond back. When accelerated thread 455 determines to wake up native thread 445, accelerated thread 455 may attempt to access a special memory address (e.g., memory address for entangled threads, memory address dedicated to entangled threads) that results in a page fault. The host/OS may be configured to be aware of an entangled thread exception (e.g., based on the page fault being associated with the special memory address). Accordingly, instead of servicing the page fault, the host/OS may put native thread 445 to an awake state (e.g., wake native thread 445 from a sleep state). Once the execution finishes (e.g., accelerator 410 finishes executing accelerated thread 455), native thread 445 may be woken up (e.g., by accelerator 410, accelerated thread 455, host, OS, etc.). Native thread 445 may read the output (e.g., result of execution) from a pre-specified location (e.g., memory of host processor 405, memory of accelerator 410) and update its instruction pointer to the next instruction in user binary that would have been run if the execution was completed natively (e.g., completed by native thread 445). The systems and methods may include a return (e.g., a normal return) to user space 415 and the application may be unaware that the task was accelerated.

Accordingly, the systems and methods include mechanisms to enable the use of hardware accelerators (e.g., accelerator 410), via providing a thread abstraction where execution transparently occurs on both host processor 405 and accelerator 410, while avoiding changes to the application software and/or avoiding or minimizing changes to the runtime system that is utilizing accelerator 410. The systems and methods may include mechanisms with and without cache coherence. The systems and methods may include mechanisms where host processor 405 and accelerator 410 are configured with or without the same ISA (e.g., using fat binaries if not). The systems and methods may include mechanisms to allow already running or newly spawned user threads to be accelerated. The systems and methods may include mechanisms where host processor 405 and accelerator 410 may or may not have shared memory.

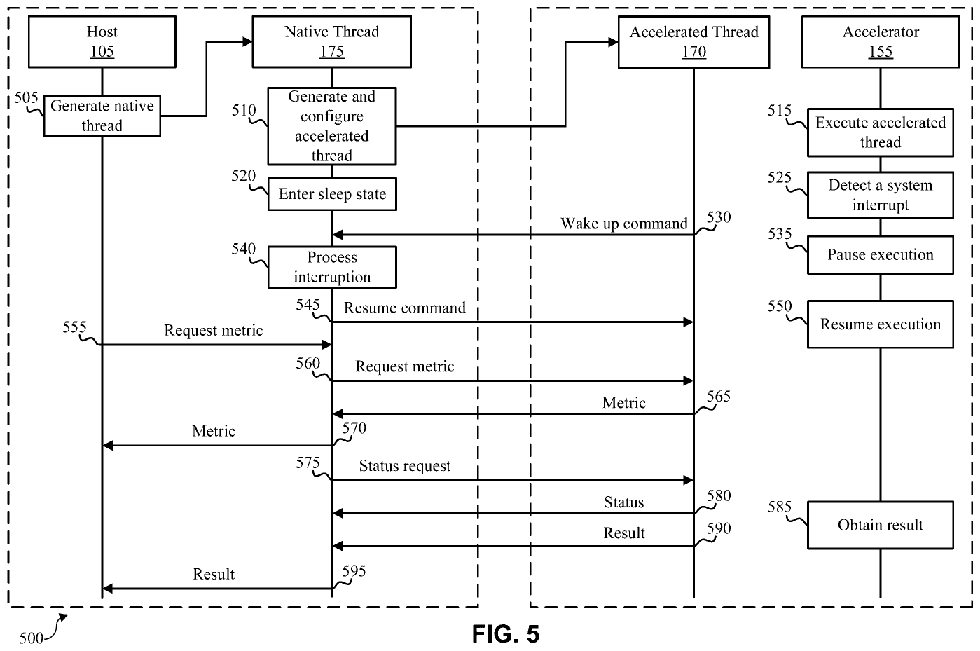

FIG. 5 depicts a flow diagram illustrating an example process flow 500 associated with the disclosed systems, in accordance with example implementations described herein. In some configurations, one or more aspects of process flow 500 may be implemented by or in conjunction with thread controller 140 of FIG. 1 and/or thread controller 230 of FIG. 2. In some configurations, one or more aspects of process flow 500 may be implemented by or in conjunction with machine 105, components of machine 105, or any combination thereof. In the illustrated example, one or more aspects of process flow 500 may be implemented by or in conjunction with host 105, native thread 175, accelerated thread 170, accelerator 155, or any combination thereof. The depicted process flow 500 is just one implementation and one or more operations of process flow 500 may be rearranged, reordered, omitted, and/or otherwise modified such that other implementations are possible and contemplated.

Although native thread 175 is depicted in a separate lane from host 105, and accelerated thread 170 is depicted in a separate lane from accelerator 155, it is understood that native thread 175 is executing on host 105 (e.g., on a processor of host 105 such as processor 110), and that accelerated thread 170 is executing on accelerator 155. Thus, native thread 175 may be considered as a part of host 105 or included in host 105, and accelerated thread 170 may be considered as a part of accelerator 155 or included in accelerator 155. Thus, an operation by native thread 175 may be performed via or in conjunction with a processor of host 105, and an operation by accelerated thread 170 may be performed via or in conjunction with accelerator 155.

At 505, host 105 may initiate a native thread (e.g., native thread 175). In some cases, host 105 may initiate the native thread based on a task (e.g., set of instructions) to be executed in association with a process (e.g., a process of an application). In some cases, host 105 may initiate native thread 175 in a user space (e.g., user space 415) and the native thread may be generated in kernel space. In some cases, a processor of host 105 (e.g., processor 110) initiates and/or generates the native thread.

At 510, native thread 175 may generate an accelerated thread (e.g., accelerated thread 170). In some cases, native thread 175 may generate accelerated thread 170 in a kernel space of host 105 (e.g., kernel space 420). In some cases, native thread 175 may configure accelerated thread 170. In some examples, native thread 175 configuring accelerated thread 170 may include native thread 175 populating a memory location on a memory of host 105 that is accessible by accelerator 155 (e.g., memory 115). Additionally, or alternatively, native thread 175 configuring accelerated thread 170 may include native thread 175 populating a memory location of a memory of accelerator 155 (e.g., accelerator memory 240). Additionally, or alternatively, native thread 175 configuring accelerated thread 170 may include native thread 175 passing a message to accelerated thread 170, without having to wait for the response (e.g., host does not actively populate any memory area, but offloads the work via passing the message, where the host does not block or wait for the response or for message transfer).

At 515, accelerator 155 may execute accelerated thread 170. For example, accelerator 155 may execute a set of instructions, where accelerated thread 170 includes the set of instructions.

At 520, native thread 175 may enter a sleep state. In some cases, native thread 175 may enter a sleep state based on native thread 175 determining or confirming that accelerator 155 has initiated execution of accelerated thread 170.

At 525, accelerator 155 may detect a system interrupt (e.g., system call).

At 530, accelerated thread 170 may generate a wake-up command and communicate the wake-up command to native thread 175 (e.g., via accelerator 155). For example, accelerated thread 170 running on the accelerator 155 may generate the wake-up command based on accelerated thread 170 running on accelerator 155 and accelerator 155 detecting the system interrupt.

At 535, accelerator 155 may pause execution of accelerated thread 170. In some cases, accelerator 155 may pause at least a portion of the execution of accelerated thread 170.

At 540, native thread 175 may process the interruption. For example, native thread 175 may perform one or more operations based on the interruption (e.g., provide information to host 105, modify a configuration of accelerated thread 170, etc.).

At 545, based on processing the interruption, native thread 175 may generate a resume command and communicate the resume command to accelerated thread 170. In some cases, native thread 175 may communicate the resume command to accelerator 155 and/or accelerated thread 170 (e.g., communicate the resume command to accelerated thread 170 via accelerator 155).

At 550, accelerator 155 may resume execution of accelerated thread 170 based on the resume command. For example, accelerator 155 may resume execution of the at least portion of the execution of accelerated thread 170 that was paused based on the system interrupt.

At 555, host 105 may host 105 may request a metric associated with execution of the task of the process. In some cases, host 105 may not be aware that the task of the process is being executed by accelerator 155 executing accelerated thread 170. Instead, host 105 may operate under the assumption that the task of the process is being executed based on a processor of host 105 executing native thread 175. Accordingly, host 105 may request from native thread 175 a metric associated with execution of the task of the process.

At 560, native thread 175 may communicate the request for the metric to accelerated thread 170 (e.g., via accelerator 155). In some cases, host 105 may communicate the request directly to accelerated thread 170 (e.g., directly to accelerated thread 170 via accelerator 155). For example, host 105 may determine that the task of the process is being executed based on accelerator 155 executing accelerated thread 170.

At 565, accelerated thread 170 may provide the requested metric to native thread 175. For example, based on the request, accelerated thread 170, via accelerator 155, may provide the requested metric to native thread 175 (e.g., native thread 175 receiving the requested metric via a processor of host 105).

At 570, native thread 175 may provide (e.g., via accelerator 155) the requested metric to host 105. In some cases, accelerated thread 170, via accelerator 155, may provide the requested metric directly to host 105.

At 575, native thread 175 may communicate a status request to accelerated thread 170. For example, native thread 175 may request a status of the execution of accelerated thread 170 by accelerator 155. In some cases, native thread 175 may communicate the status request to accelerated thread 170 via accelerator 155.

At 580, accelerated thread 170 may provide the requested status to native thread 175. For example, based on the status request, accelerated thread 170, via accelerator 155, may provide the requested status to native thread 175. In some cases, native thread 175, via a processor of host 105, may store the status in a preconfigured memory location. For example, native thread 175 may store the status in a memory of host 105 (e.g., memory 115), in a memory of accelerator 155 (e.g., accelerator memory 240), and/or in memory shared by host 105 and accelerator 155 (e.g., memory 115 and/or accelerator memory 240).

At 585, accelerator 155 may obtain a result (e.g., one or more results) based on accelerator 155 executing accelerated thread 170. For example, accelerator 155 executing accelerated thread 170 may result in accelerator 155 computing one or more results.

At 590, accelerated thread 170 may provide the result to native thread 175. For example, based on execution of accelerated thread 170, accelerated thread 170 may provide the result to native thread 175 via accelerator 155.

At 595, native thread 175 may provide the result to host 105 (e.g., to an operating system of host 105, to a user-level application executing on host 105, etc.). For example, native thread 175 may receive the result from accelerated thread 170 via host 105. In some cases, accelerated thread 170 may provide the result directly to host 105 via accelerator 155.

In one or more examples, accelerated thread 170 and/or native thread 175 may be terminated based on completion of executing the task of the process via accelerated thread 170 (e.g., completing execution of one or more function of the task). In some cases, native thread 175, host 105, and/or accelerator 155 may terminate accelerated thread 170 (e.g., accelerated thread 170 enters terminated state). In some cases, accelerated thread 170 may terminate itself. In some examples, native thread 175, host 105, and/or accelerator 155 may terminate native thread 175. In some cases, native thread 175 may terminate itself.

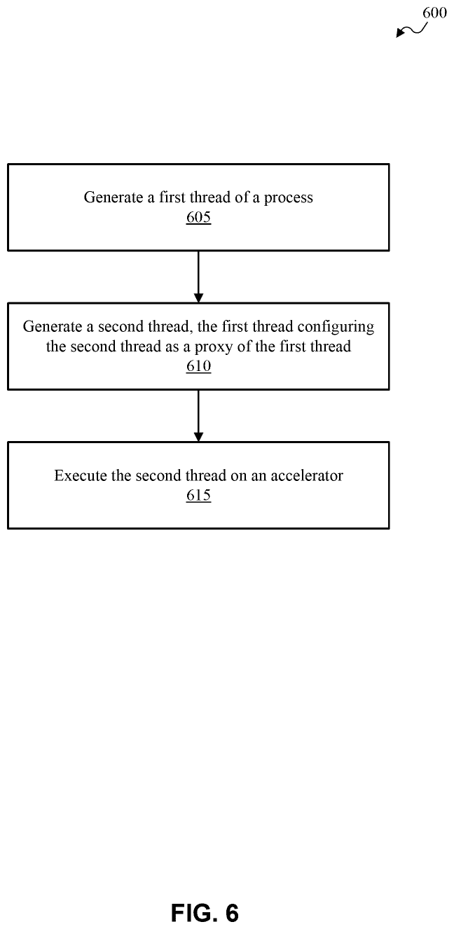

FIG. 6 depicts a flow diagram illustrating an example method 600 associated with the disclosed systems, in accordance with example implementations described herein. In some configurations, one or more aspects of method 600 may be implemented by or in conjunction with thread controller 140 of FIG. 1 and/or thread controller 230 of FIG. 2. In some configurations, one or more aspects of method 600 may be implemented by or in conjunction with machine 105, components of machine 105, or any combination thereof. The depicted method 600 is just one implementation and one or more operations of method 600 may be rearranged, reordered, omitted, and/or otherwise modified such that other implementations are possible and contemplated.

At 605, method 600 may include generating, via a host, a first thread of a process. For example, method 600 may include host 105 generating native thread 175 based on a set of instructions of a process, where the process may be part of an application.

At 610, method 600 may include generating, via the first thread, a second thread, the first thread configuring the second thread as a proxy of the first thread. For example, method 600 may include native thread 175 generating accelerated thread 170, where native thread 175 configures accelerated thread 170 as a proxy of native thread 175.

At 615, method 600 may include executing the second thread on an accelerator. For example, method 600 may include executing accelerated thread 170 on accelerator 155.

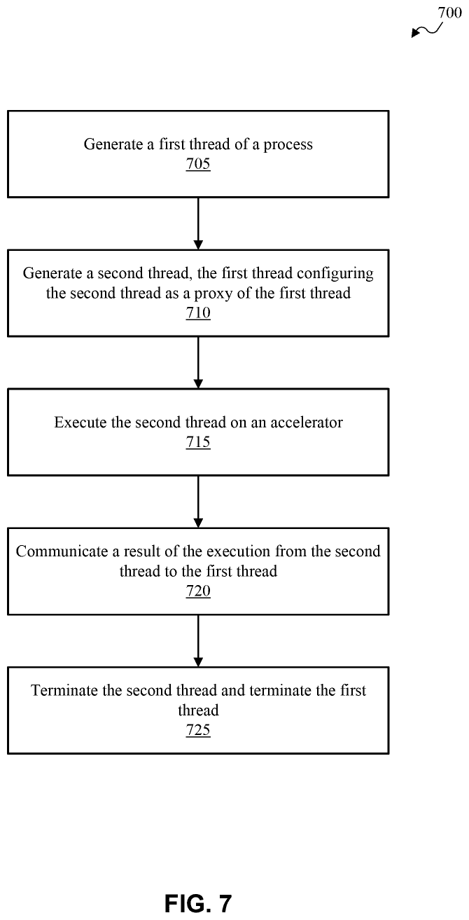

FIG. 7 depicts a flow diagram illustrating an example method 700 associated with the disclosed systems, in accordance with example implementations described herein. In some configurations, one or more aspects of method 700 may be implemented by or in conjunction with thread controller 140 of FIG. 1 and/or thread controller 230 of FIG. 2. In some configurations, one or more aspects of method 700 may be implemented by or in conjunction with machine 105, components of machine 105, or any combination thereof. The depicted method 700 is just one implementation and one or more operations of method 700 may be rearranged, reordered, omitted, and/or otherwise modified such that other implementations are possible and contemplated.

At 705, method 700 may include generating, via a host, a first thread of a process. For example, method 700 may include host 105 generating native thread 175 based on a set of instructions of a process, where the process may be part of an application.

At 710, method 700 may include generating, via the first thread, a second thread, the first thread configuring the second thread as a proxy of the first thread. For example, method 700 may include native thread 175 generating accelerated thread 170, where native thread 175 configures accelerated thread 170 as a proxy of native thread 175.

At 715, method 700 may include executing the second thread on an accelerator. For example, method 700 may include executing accelerated thread 170 on accelerator 155.

At 720, method 700 may include communicating a result of the execution from the second thread to the first thread. For example, method 700 may include accelerated thread 170 communicating a result of the execution to native thread 175. In some cases, method 700 may include native thread 175 communicating the result of the execution to host 105.

At 725, method 700 may include terminating the second thread and terminating the first thread. For example, based on the result being communicated to host 105, method 700 may include native thread 175 terminating accelerated thread 170, and/or host 105 terminating native thread 175.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wired and/or wireless communication device such as a switch, router, network interface controller, cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be wireless, wired, mobile, and/or stationary.

As used within this document, the term “communicate” is intended to include transmitting, or receiving, or both transmitting and receiving. Similarly, the bidirectional exchange of data between two devices (both devices transmit and receive during the exchange) may be described as ‘communicating’, when only the functionality of one of those devices is being claimed. The term “communicating” as used herein with respect to wired and/or wireless communication signals includes transmitting the wired and/or wireless communication signals and/or receiving the wired and/or wireless communication signals. For example, a communication unit, which is capable of communicating wired and/or wireless communication signals, may include a wired/wireless transmitter to transmit communication signals to at least one other communication unit, and/or a wired/wireless communication receiver to receive the communication signal from at least one other communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global

Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples as set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of entangling threads, the method comprising:
generating, via a host, a first thread of a process;
generating, via the first thread, a second thread, the first thread configuring the second thread as a proxy of the first thread; and
executing the second thread on an accelerator.

2. The method of claim 1, wherein:
the first thread is generated in a user memory space of the host, and
the first thread enters a sleep state in a kernel memory space of the host.

3. The method of claim 2, wherein the first thread places itself in the sleep state based on the second thread executing on the accelerator.

4. The method of claim 2, wherein:
the second thread is generated in the kernel memory space of the host, and
the second thread executes in a memory space of the accelerator.

5. The method of claim 1, further comprising:
configuring, via the host, the first thread to execute on a processor of the host; and
configuring, via the first thread, the second thread to execute on the accelerator.

6. The method of claim 1, wherein, upon completing execution, the second thread provides a result of the execution to the first thread.

7. The method of claim 1, wherein the first thread determines execution of the second thread is complete based on the first thread periodically polling the second thread.

8. The method of claim 1, wherein the accelerator executing the second thread is viewed by the host as the first thread executing on a processor of the host.

9. The method of claim 1, wherein the first thread configuring the second thread comprises the first thread populating a memory location on a memory of the host that is accessible by the accelerator.

10. The method of claim 1, wherein the first thread configuring the second thread comprises the first thread populating a memory location of a memory of the accelerator.

11. The method of claim 1, wherein the first thread configuring the second thread comprises the first thread passing a message to the second thread that bypasses a processor of the host.

12. The method of claim 1, further comprising:
waking the first thread from a sleep state based on the second thread detecting a system interrupt and the second thread sending a wake-up command to the first thread; and
pausing execution of the second thread.

13. The method of claim 12, further comprising:
processing, via the first thread, the system interrupt; and
resuming execution of the second thread based on the second thread receiving a resume command from the first thread.

14. The method of claim 1, wherein the first thread requests a metric from the second thread based on the first thread receiving a request for the metric from the host.

15. The method of claim 1, wherein the host requests a metric from the second thread based on the host detecting that the second thread is the proxy of the first thread.

16. The method of claim 1, wherein the host fetches a metric from a memory location of the accelerator to determine a status associated with execution of the second thread.

17. The method of claim 1, wherein the second thread comprises a pre-compiled binary packaged as a multiarchitecture binary.

18. A device comprising:
one or more processors; and
memory storing instructions that, when executed by the one or more processors, cause the device to:
generate, via a host, a first thread of a process;
generate, via the first thread, a second thread, the first thread configuring the second thread as a proxy of the first thread; and
execute the second thread on an accelerator.

19. The device of claim 18, wherein:
the first thread is generated in a user memory space of the host, and
the first thread enters a sleep state in a kernel memory space of the host.

20. A non-transitory computer-readable medium storing code that comprises instructions executable by a processor of a device to:
generate, via a host, a first thread of a process;
generate, via the first thread, a second thread, the first thread configuring the second thread as a proxy of the first thread; and
execute the second thread on an accelerator.
